(19) United States
(12) Patent Application Publication
(10) Pub. No.: US 2013/0205173 A1
(43) Pub. Date: Aug. 8, 2013

(54) STORAGE DEVICE, AND STORAGE DEVICE CONTROL METHOD

(71) Applicant: FUJITSU LIMITED, Kawasaki-shi (JP)

(72) Inventor: Yusuke YONEDA, Kahoku (JP)

(21) Appl. No.: 13/710,522

(22) Filed: Dec. 11, 2012

(30) Foreign Application Priority Data
Feb. 3, 2012 (JP) 2012-022327

(51) Int. Cl. G06F 11/34

(52) U.S. Cl. CPC G06F 11/3409
USPC 714/47.2

(57) ABSTRACT

A storage device, which performs input/output processing on a memory device through a relay apparatus, includes a memory and a processor coupled to the memory. The processor executes a process including: determining whether or not a cumulative value accumulated according to occurrence of error in the memory device during the input/output processing reaches a predetermined threshold value; comparing when the determined cumulative value is greater than or equal to the threshold value, number of input/output processing on the memory device with number of input/output processing on another memory device mounted on the relay apparatus, and determining whether or not there is a bias; determining when the bias is determined, whether or not a connection status is normal with respect to the relay apparatus; and detaching when it is determined that the connection status of the relay apparatus is normal, the connection to the memory device.

### CROSS-REFERENCE TO RELATED APPLICATION

This application is based upon and claims the benefit of priority of the prior Japanese Patent Application No. 2012-022327, filed on Feb. 3, 2012, the entire contents of which are incorporated herein by reference.

### FIELD

The embodiments discussed herein are related to a storage device, and a storage device control method.

### BACKGROUND

Conventionally, a storage device has a high storage capacity because a plurality of Hard Disk Drives (HDDs) (hereinafter, referred to as disks) are connected through a Serial Attached SCSI (SAS) Expander (hereinafter, referred to as an expander). A related storage device will be described with reference to FIG. 8.

FIG. 8 is a diagram illustrating an example of a configuration of a related storage device. As illustrated in FIG. 8, a storage device 900 includes expanders 910 to 930 and an I/O controller 940. Also, in the storage device 900, a device located relatively on an I/O controller 940 side will be referred to as an upper device, and a device located relatively on an expander 930 side will be referred to as a lower device.

In such a storage device 900, the I/O controller 940 performs discovery processing on the respective expanders to acquire connection information of the expanders or disks, and performs input/output processing on the disks, based on the acquired connection information.

Also, when an abnormality, such as link-down, occurs in a path within the storage device 900, the I/O controller 940 stops I/O access to a disk that uses the path where the link-down occurs. In this case, the I/O controller 940 may detect that I/O is in error, but does not specify whether an abnormal device is the disk or the expander, until waiting for the completion of the discovery processing. Also, when it takes time to perform the discovery processing, the I/O controller 940 does not specify the abnormal device, and therefore, the I/O controller 940 continuously detects the error of the I/O access during that time.

In this regard, the I/O controller 940 specifies the abnormal device by performing statistical monitoring of the I/O error. For example, when the I/O error occurs, the I/O controller 940 performs a point addition to point that evaluate errors associated with the disk where the error occurs and the expander mounted with the disk, and specifies a device, of which a cumulative value of points is greater than or equal to a threshold value, as the abnormal device.

The processing of specifying the abnormal device by the statistical monitoring of the I/O error will be described with reference to FIGS. 9A and 9B. FIG. 9A is a diagram illustrating an example of a point addition of I/O errors that occur in disks mounted on the same expander, and FIG. 9B is a diagram illustrating an example of a point addition of I/O errors that occur in disks mounted on different expanders. Also, when I/O error occurs, the I/O controller 940 performs a point addition to points that evaluate errors associated with the respective I/O-accessed disks and the entire expanders on paths leading to the disks. Also, for example, one-time added point value (P_{EXP}) to points evaluating the error associated with the expander is 50 points, an added value (P_{DISK}) to points evaluating the error associated with the disk is 65 points, and a threshold value of points specifying the device as the abnormal area is 255 points. Also, when points of a plurality of expanders are greater than or equal to a threshold value at the same time, the expander located at the lowest position is detached.

The example illustrated in FIG. 9A indicates a case where there is an abnormality in the expander 930. When the I/O controller 940 performs I/O accesses in the order of a disk 931, a disk 932, a disk 933, and a disk 934, all become errors. In this case, whenever the accesses to the respective disks 931 to 934 are failed, the statistical point addition is performed to add points to the respective I/O-accessed disks 931 to 934 and the expander 930. As a result, when the I/O access to the disk 932 is failed for the second time, the points of the expander 930 exceed the threshold value, that is, 255 points. The I/O controller 940 specifies the expander 930 as the abnormal device, and detaches the expander 930.

The example illustrated in FIG. 9B indicates a case where there is an abnormality in the expander 910. When the I/O controller 940 performs I/O accesses in the order of a disk mounted on the expander 910, a disk mounted on the expander 920, and a disk mounted on the expander 930, all I/O accesses become errors. In this case, whenever the accesses to the respective disks are failed, points are added to the expander and expanders located above the expander. As a result, when the access to the disk mounted on the expander 930 is failed for the second time, the points of the expander 910 exceed the threshold value, that is, 255 points. The I/O controller 940 specifies the expander 910 as the abnormal device, and detaches the expander 910.

[Patent Literature 1] Japanese Laid-open Patent Publication No. 2009-205316

[Patent Literature 2] Japanese Laid-open Patent Publication No. 2011-108006

[Patent Literature 3] Japanese Laid-open Patent Publication No. 2008-242872

However, in the related technology described above, there is a problem that may mistakenly detach normal components.

A case of mistakenly detaching a normal component by statistical monitoring of I/O error will be described with reference to FIGS. 10A and 10B. FIG. 10A is a diagram illustrating another example of a point addition of I/O errors that occur in disks mounted on the same expander, and FIG. 10B is a diagram illustrating another example of a point addition of I/O errors that occur in disks mounted on different expanders.

The example illustrated in FIG. 10A indicates a case where there is an abnormality in the expander 930. When the I/O controller 940 repetitively performs I/O accesses to the disk 931, all I/O accesses become errors. When the I/O access to the disk 931 is failed for the fourth time, the points of the disk 931 exceed the threshold value, that is, 255 points. As a result, the I/O controller 940 specifies the disk 931 as the abnormal device, and mistakenly detaches the normal disk 931. Also, even when there are I/O accesses to a plurality of disks but there is a great bias in the I/O accesses, the disks are mistakenly detached before the abnormality of the expander is detected.

The example illustrated in FIG. 10B indicates a case where there is an abnormality in the expander 910. When the I/O controller 940 alternately repeats I/O accesses to a disk mounted on the expander 920 and a disk mounted on the expander 930, all I/O accesses become errors. When the access to the disk mounted on the expander 930 is failed for the third time, the points of the expander 910 and the expander 920 exceed the threshold value, that is, 255 points. As a result, the I/O controller 940 specifies the normal expander 920 as the abnormal device, and detaches the expander 920 mistakenly.

### SUMMARY

According to an aspect of an embodiment, a storage device performs input/output processing on a memory device through a relay apparatus. The storage device includes a memory; and a processor coupled to the memory, wherein the processor executes a process including: determining whether or not a cumulative value accumulated according to occurrence of error in the memory device during the input/output processing reaches a predetermined threshold value; comparing when the determined cumulative value is greater than or equal to the threshold value, number of input/output processing on the memory device with number of input/output processing on another memory device mounted on the relay apparatus, and determining whether or not there is a bias; determining when the bias is determined, whether or not a connection status is normal with respect to the relay apparatus; and detaching when it is determined that the connection status of the relay apparatus is normal, the connection to the memory device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a hardware configuration of a storage device according to a first embodiment;

FIG. 2 is a functional block diagram illustrating a functional configuration of a control program that is executed by the storage device according to the first embodiment;

FIG. 3 is a diagram illustrating an example of information that is stored by a statistical point addition table;

FIG. 4 is a flow chart illustrating a processing procedure of processing by the storage device according to the first embodiment;

FIG. 5 is a flow chart illustrating a processing procedure of processing by the storage device according to the first embodiment;

FIG. 6 is a flow chart illustrating a processing procedure of processing by the storage device according to the first embodiment;

FIG. 7 is a diagram illustrating a computer that executes a storage device control program;

FIG. 8 is a diagram illustrating an example of a configuration of a related storage device;

FIG. 9A is a diagram illustrating an example of a point addition of I/O errors that occur in disks mounted on the same expander;

FIG. 9B is a diagram illustrating an example of a point addition of I/O errors that occur in disks mounted on different expanders;

FIG. 10A is a diagram illustrating another example of a point addition of I/O errors that occur in disks mounted on the same expander; and

FIG. 10B is a diagram illustrating another example of a point addition of I/O errors that occur in disks mounted on different expanders.

### DESCRIPTION OF EMBODIMENTS

Preferred embodiments of the present invention will be explained with reference to accompanying drawings. Also, the invention is not limited by these embodiments. The respective embodiments may be appropriately combined within a scope that does not contradict the contents of processing.

### [a] First Embodiment

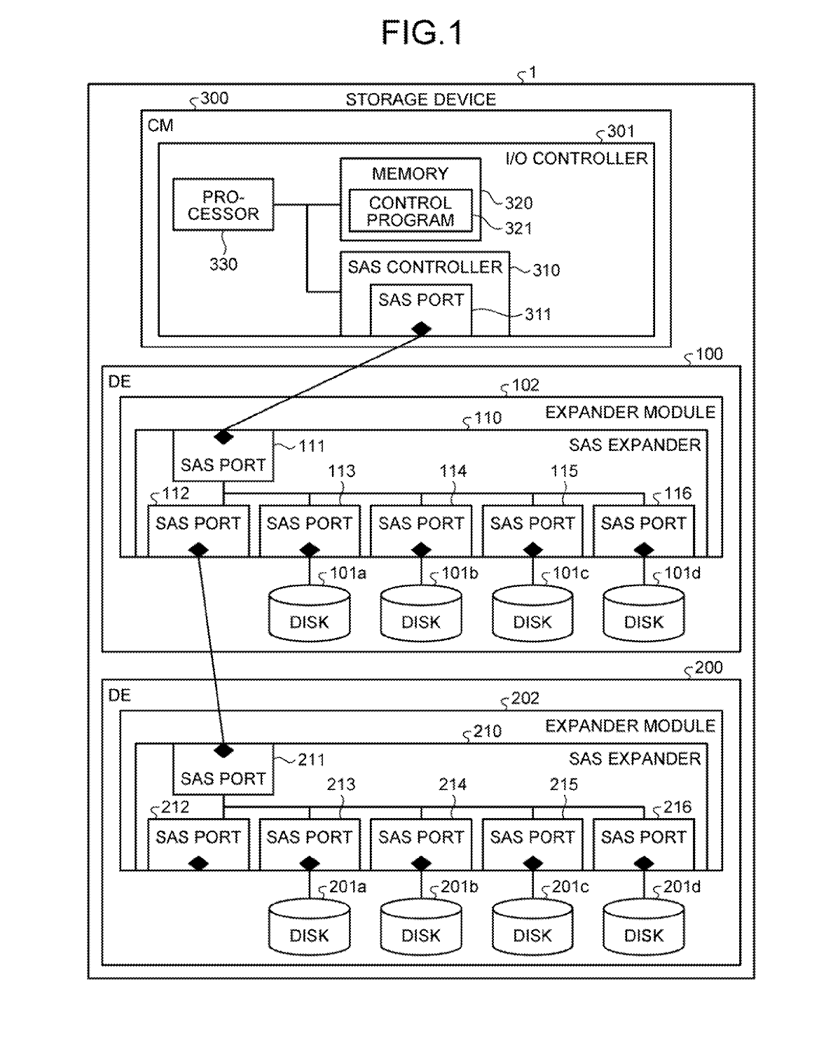

In a first embodiment, a configuration of a storage device, a functional configuration of a processing unit realized by a firmware executed by the storage device, a processing procedure, effects, and the like will be described with reference to FIGS. 1 to 6.

Configuration of Storage Device

FIG. 1 is a diagram illustrating an example of a hardware configuration of a storage device according to a first embodiment. As illustrated in FIG. 1, the storage device 1 according to the first embodiment includes Device Enclosures (DEs) 100 and 200, and a Controller Module (CM) 300. Also, the number of the DEs included in the storage device 1 is not limited to the illustration, and may be arbitrarily changed.

The DE 100 includes disks 101a to 101d, and an expander module 102. The disks 101a to 101d are memory devices such as, for example, HDDs. Also, the number of the disks included in the DE 100 is not limited to the illustration, and may be arbitrarily changed if one or more disks are mounted thereon.

The expander module 102 includes a SAS expander 110 (hereinafter, referred to as an expander 110). The expander 110 includes SAS ports 111 to 116, and controls input/output processing between the CM 300 and the disks 101a to 101d, or between the CM 300 and the DE 200.

For example, the SAS port 111 is connected to a SAS port included in the CM 300, which is to be described later, and controls input/output processing from the CM 300. The SAS port 112 is connected to a SAS port 211 included in the DE 200, and controls input/output processing to the DE 200. The SAS port 113 is connected to the disk 101a, and controls input/output processing to the disk 101a. The SAS port 114 is connected to the disk 101b, and controls input/output processing to the disk 101b. The SAS port 115 is connected to the disk 101c, and controls input/output processing to the disk 101c. The SAS port 116 is connected to the disk 101d, and controls input/output processing to the disk 101d.

The DE 200 includes disks 201a to 201d, and an expander module 202. The disks 201a to 201d are memory devices such as, for example, HDDs. Also, the number of the disks included in the DE 200 is not limited to the illustration, and may be arbitrarily changed if one or more disks are mounted thereon.

The expander module 202 includes a SAS expander 210 (hereinafter, referred to as an expander 210). The expander 210 includes SAS ports 211 to 216, and controls input/output processing between the CM 300 and the disks 201a to 201d. Also, when a DE 400 is newly connected under the DE 200, the expander 210 controls input/output processing between the CM 300 and the DE 400.

For example, the SAS port 211 is connected to the SAS port 112 included in the DE 100, and controls input/output processing from the DE 100. When the DE 400 is newly connected under the DE 200, the SAS port 212 is connected to a SAS included in the DE 400, and controls input/output processing to the DE 400. The SAS port 213 is connected to the disk 201a, and controls input/output processing to the disk 201a. The SAS port 214 is connected to the disk 201b, and controls input/output processing to the disk 201b. The SAS port 215 is connected to the disk 201c, and controls input/output processing to the disk 201c. The SAS port 216 is connected to the disk 201d, and controls input/output processing to the disk 201d.

The CM 300 includes an I/O controller 301, and controls execution of processing of input/output received from a server that is not illustrated. The I/O controller 301 includes a SAS controller 310, a memory 320, and a processor 330.

The SAS controller 310 includes a SAS port 311. The SAS port 311 is connected to the SAS port 111 included in the DE 100.

The memory 320 is a semiconductor memory device such as, for example, a Random Access Memory (RAM). The memory 320 stores a program or data that is used by the I/O controller 301. Also, the memory 320 stores a control program 321.

The processor 330 is an electronic circuit such as, for example, a Central Processing Unit (CPU) or a Micro Processing Unit (MPU), and performs a variety of operations or a variety of processing by the I/O controller 301.

Also, by causing the processor 330 to read the control program 321 from the memory 320 and execute the read control program 321, the storage device 1 performs the following processing. That is, the storage device 1 performing input/output processing on the disk through the expander determines whether or not a cumulative value accumulated according to occurrence of error in the disk during the input/output processing reaches a predetermined threshold value. Also, when it is determined that the cumulative value is greater than or equal to the threshold value, the storage device 1 compares the number of input/output processing on the disk with the number of input/output processing on other disk mounted on the expander, and determines whether or not there is a bias. Subsequently, when it is determined that there is the bias, the storage device 1 determines whether or not a connection status is normal with respect to the expander. When it is determined that the connection status of the expander is normal, the storage device 1 detaches the connection to the disk.

Functional Configuration of Processing Unit Realized by Firmware

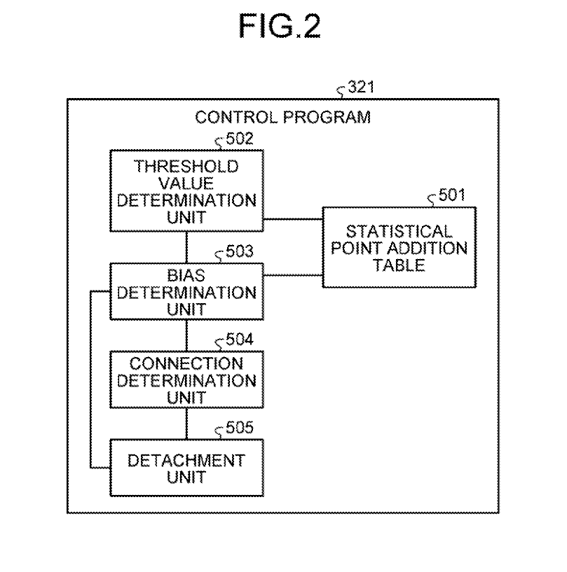

Next, the functional configuration of the control program 321, which is executed by the storage device 1 according to the first embodiment, will be described with reference to FIG. 2. FIG. 2 is a functional block diagram illustrating the functional configuration of the control program 321, which is executed by the storage device according to the first embodiment. Also, the control program 321, which is executed by the storage device 1, is realized in cooperation with the memory 320 and the processor 330.

As illustrated in FIG. 2, the control program 321 includes a statistical point addition table 501, a threshold value determination unit 502, a bias determination unit 503, a connection determination unit 504, and a detachment unit 505.

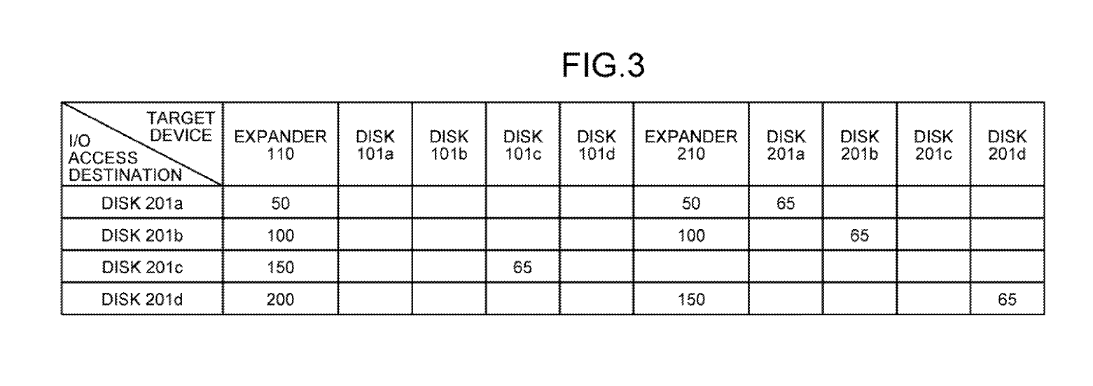

The statistical point addition table 501 stores information in which an I/O access destination and a cumulative value of points, which are added to a device when an error occurs in the I/O access destination, are associated with each other. The information stored by the statistical point addition table 501 will be described with reference to FIG. 3.

FIG. 3 is a diagram illustrating an example of the information stored by the statistical point addition table. As illustrated in FIG. 3, the statistical point addition table 501 stores information in which an “I/O access destination” and a “target device” are associated with each other. The “I/O access destination” represents disks that I/Os have been issued to. For example, the “disk 201a”, the “disk 201b”, the “disk 201c”, and the like are stored in the “I/O access destination”. Also, the order of being stored in the “I/O access destination” corresponds to the order of issuing the I/O access.

The “target device” represents devices that are subject to the point addition when errors occur in I/O accesses. For example, the “expander 110”, the “disk 101a”, the “disk 101b”, the “disk 101c”, and the “disk 101d” are stored in the “target device”. Also, the “expander 210”, the “disk 201a”, the “disk 201b”, the “disk 201c”, and the “disk 201d” are stored in the “target device”.

The example of FIG. 3 indicates that an error occurs in the I/O access issued to the disk 201a and, as a result of adding 50 points to the expander 110 and the expander 210, the cumulative value of points become 50 points. Also, it is indicated that, as a result of adding 65 points to the disk 201a, the cumulative value of points become 65 points. Also, in the statistical point addition table 501, whenever the I/O access is issued, the “I/O access destination” is added by the threshold value determination unit 502, which is to be described later, and data is updated. Also, when the I/O access is normally performed, no points are added to the “target device”, and only the “I/O access destination” is newly added.

Whenever an error occurs in input/output processing performed on a certain disk through the expander mounted with one or more disks, the threshold value determination unit 502 adds points to the corresponding disk and the expander located on the path of the input/output processing to the corresponding disk.

For example, when I/O error occurs, the threshold value determination unit 502 performs the point addition to points associated with the respective I/O-accessed disks, which correspond to the “target device” stored by the statistical point addition table 501, and the entire expanders on the path leading to the disks. The threshold value determination unit 502 sets 50 points as one-time added value (P_{EXP}) to the expander, sets 65 points as the added value (P_{DISK}) to the disk, and sets 255 points as the threshold value of points specifying the device as the abnormal area.

The threshold value determination unit 502 determines whether or not the cumulative value of points of the disk or the expander is greater than or equal to a predetermined threshold value. For example, when it is determined that the cumulative value added to the points associated with the disk is greater than or equal to the threshold value, that is, 255 points, the threshold value determination unit 502 notifies the bias determination unit 503 of determining whether or not there is the bias in the input/output processing.

Also, when it is determined that the cumulative value of points associated with the expander is greater than or equal to the predetermined threshold value, the threshold value determination unit 502 notifies the connection determination unit 504 of specifying the abnormal expander.

Also, when it is determined that the cumulative value added to either of the disk and the expander is not greater than or equal to the predetermined threshold value, the threshold value determination unit 502 adds points to the disk and the expander whenever the error continuously occurs in the input/output processing.

When it is determined by the threshold value determination unit 502 that the cumulative value added to the points associated with a certain disk is greater than or equal to the threshold value, the bias determination unit 503 determines whether or not there is the bias in the input/output processing.

For example, when I/O flows to two or more disks, the bias determination unit 503 determines a situation of issuing I/Os to the respective disks, and calculates the number of I/O issues (IO_{MAX}) to the disk through which I/O maximally flows. Also, the bias determination unit 503 calculates the number of I/O issues (IO₀, IO₁, . . . , IO_{N-1}) to the other disks.

Assuming that the one-time added point value to the expander is P_{EXP} and the added point value to the disk is P_{DISK}, the bias determination unit 503 determines that there is the bias in the I/O when an I/O issue ratio satisfies a condition of Equation (1) below.

IO_{MAX}×(P_{DISK}−P_{EXP})>(IO₀+IO₁+ . . . +IO_{N-1})×P_{EXP} (1)

Next, a method of calculating Equation (1) will be described. When the added point value of the disk exceeds the added point value of the expander, it is likely to be misdiagnosed as disk detachment in the event of expander abnormality caused by I/O bias. When there is the abnormality in the expander, errors occur in all mounted disks, but errors easily occur as the number of I/O issues increases. Therefore, the disk having the largest number of I/O issues is subject to detachment for the first time.

Among the N disks, I/O to the disk having the largest number of I/O issues is referred to as IO_{MAX}, and I/Os to the remaining disks are referred to as IO₀ to IO_{N-1}. The condition that the disk detachment is falsely detected, that is, the condition of the case where the added point value of the disk exceeds the added point value of the expander, is expressed as Equation (2) below.

IO_{MAX}×P_{DISK}>IO_{MAX}×P_{EXP}+IO₀×P_{EXP}+IO₁×P_{EXP}+ . . . +IO_{N-1}×P_{EXP} (2)

Equation (2) is modified into Equation (1).

When it is determined that there is no bias in the input/output processing, the bias determination unit 503 specifies the disk, of which the cumulative value is greater than or equal to the threshold value, as the abnormal device.

Also, when it is determined that there is the bias in the input/output processing, the bias determination unit 503 causes the connection determination unit 504 to determine whether or not the connection status is normal with respect to the expander mounted with the disk that is greater than or equal to the threshold value. When it is notified from the connection determination unit 504 that the expander mounted with the disk, of which the cumulative value of points is greater than or equal to the threshold value, is normal, the bias determination unit 503 specifies the disk, of which the cumulative value of points is greater than or equal to the threshold value, as the abnormal device.

When it is determined by the bias determination unit 503 that there is the bias, the connection determination unit 504 determines whether or not the connection status is normal with respect to the expander mounted with the disk, of which the cumulative value of points is greater than or equal to the threshold value. When it is determined that the connection status of the expander mounted with the disk, of which the cumulative value of points is greater than or equal to the threshold value, is normal, the connection determination unit 504 notifies the bias determination unit 503 that the expander mounted with the disk, of which the cumulative value of points is greater than or equal to the threshold value, is normal.

Also, when it is determined that the connection status of the expander mounted with the disk, of which the cumulative value of points is greater than or equal to the threshold value, is abnormal, the connection determination unit 504 specifies the abnormal expander. Also, when it is determined by the threshold value determination unit 502 that a certain expander is greater than or equal to the threshold value, the connection determination unit 504 specifies the abnormal expander.

The processing of specifying the abnormal expander by the connection determination unit 504 will be described. For example, the connection determination unit 504 sets the expander mounted with the disk, of which the cumulative value of points is greater than or equal to the threshold value, or the expander, of which the cumulative value of points is greater than or equal to the threshold value, as a detachment candidate. Also, when there exist a plurality of expanders, of which the cumulative value of points is greater than or equal to the threshold value, the connection determination unit 504 sets the lowest expander as the detachment candidate.

The connection determination unit 504 determines whether or not I/Os are issued to the entire expanders on the path to the expander, which is the detachment candidate. When the I/Os are issued to the entire expanders, the connection determination unit 504 specifies the expander, which is the detachment candidate, as the abnormal device.

Subsequently, when no I/Os are issued to the entire expanders, the connection determination unit 504 determines whether or not the connection status is normal with respect to the entire expanders located above the expander. When it is determined that the connection status is normal with respect to the entire expanders located above, the connection determination unit 504 specifies the expander, which is the detachment candidate, as the abnormal device.

Also, when it is determined that the connection status is abnormal with respect to the entire expanders located above, the connection determination unit 504 specifies the expander, which is located at the highest position, as the abnormal device among the expanders being in the abnormal connection status.

The detachment unit 505 detaches the device that is specified as abnormal by the bias determination unit 503 or the connection determination unit 504. For example, the detachment unit 505 detaches the expander located at the highest position among the expanders, of which the connections are determined as abnormal by the connection determination unit 504.

Also, for example, when it is determined by the connection determination unit 504 that the connection status of the expander mounted with the disk being greater than or equal to the threshold value is normal, the detachment unit 505 detaches the connection to the disk being greater than or equal to the threshold value. Also, when it is determined by the bias determination unit 503 that there is no bias in the input/output processing, the detachment unit 505 detaches the disk that is determined as greater than or equal to the threshold value by the threshold value determination unit 502.

Processing Procedure of Processing by Storage Device According to First Embodiment

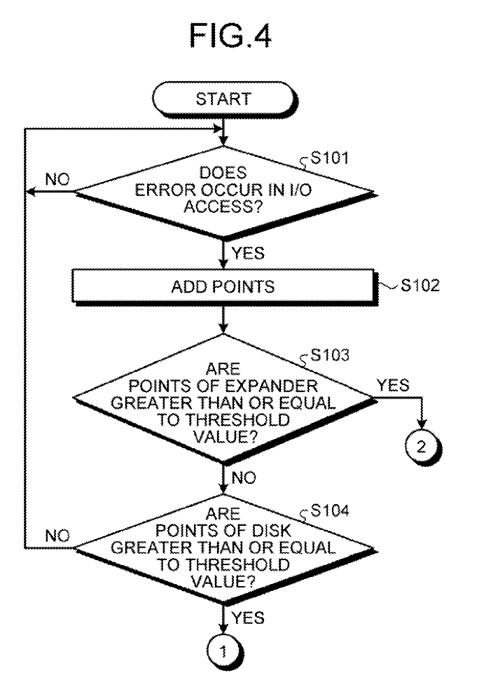

Next, the processing procedure of the processing by the storage device according to the first embodiment will be described with reference to FIGS. 4 to 6. FIGS. 4 to 6 are flow charts illustrating the processing procedure of the processing by the storage device according to the first embodiment.

As illustrated in FIG. 4, the threshold value determination unit 502 determines whether or not an error occurs in I/O access (step S101). When it is determined that the error occurs in the I/O access (Yes in step S101), the threshold value determination unit 502 adds points (step S102). For example, the threshold value determination unit 502 adds predetermined points to a disk in which an I/O access error occurs, an expander mounted with the disk, and an expander located above the expander.

The threshold value determination unit 502 determines whether or not a cumulative value of points of a certain expander is greater than or equal to a threshold value (step S103). When it is determined that the cumulative value of the points of the certain expander is greater than or equal to the threshold value (Yes In step S103), the threshold value determination unit 502 proceeds to step S113.

On the other hand, when it is determined that the cumulative value of the points of the certain expander is not greater than or equal to the threshold value (No In step S103), the threshold value determination unit 502 determines whether or not a cumulative value of points of a certain disk is greater than or equal to the threshold value (step S104). When it is determined that the cumulative value of the points of the certain disk is greater than or equal to the threshold value (Yes In step S104), the threshold value determination unit 502 proceeds to step S105. On the other hand, when it is determined that the cumulative value of the points of the certain disk is not greater than or equal to the threshold value (No In step S104), the threshold value determination unit 502 proceeds to step S101.

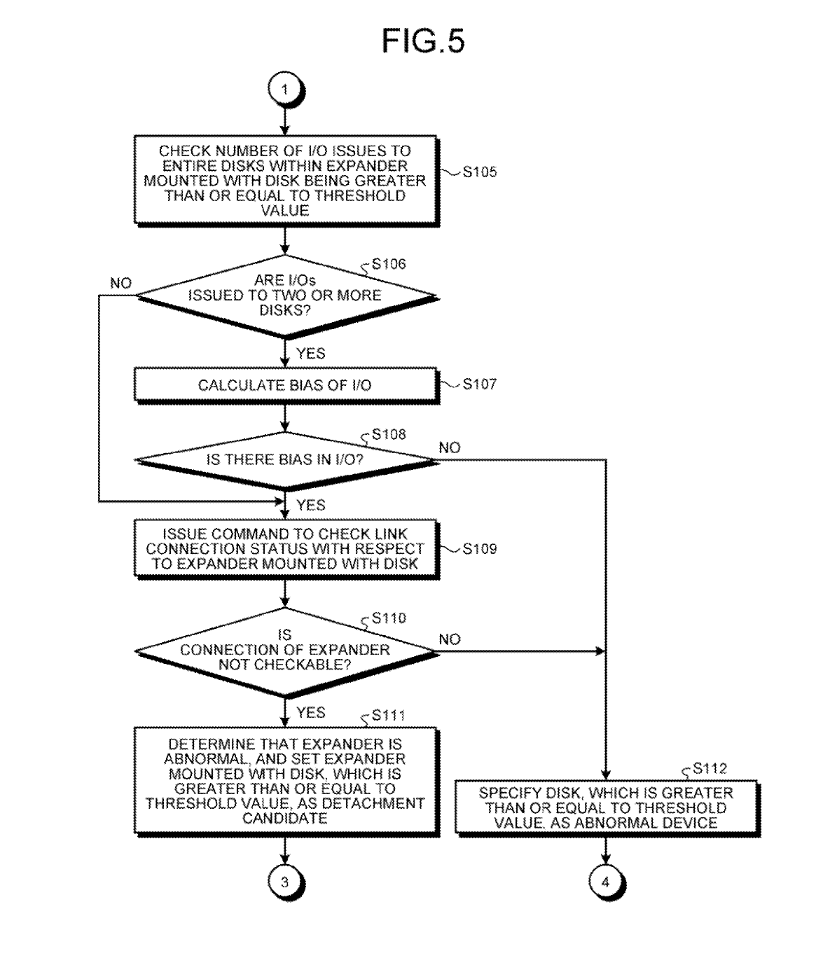

Next, a processing procedure after proceeding to step S105 will be described with reference to FIG. 5. The bias determination unit 503 checks the number of I/O issues to the entire disks within the expander mounted with the disk being greater than or equal to the threshold value (step S105). The bias determination unit 503 determines whether or not I/Os are issued to two or more disks (step S106).

When it is determined that no I/Os are issued to two or more disks (No in step S106), the bias determination unit 503 proceeds to step S109. On the other hand, when it is determined that the I/Os are issued to two or more disks (Yes in step S106), the bias determination unit 503 calculates the bias of the I/Os (step S107).

The bias determination unit 503 determines whether or not there is the bias in the I/Os (step S108). When it is determined that there is no bias in the I/Os (No in step S108), the bias determination unit 503 proceeds to step S112. On the other hand, when it is determined that there is the bias in the I/Os (Yes in step S108), the bias determination unit 503 proceeds to step S109.

In step S109, the connection determination unit 504 issues a command to check a link connection status with respect to the expander mounted with the disk (step S109). The connection determination unit 504 determines whether the connection of the expander is not checkable (step S110).

When it is determined that the connection of the expander is not checkable (Yes in step S110), the connection determination unit 504 performs the following processing. That is, the connection determination unit 504 determines that the expander is abnormal, sets the expander mounted with the disk, which is greater than or equal to the threshold value, as a detachment candidate (step S111), and proceeds to step S116. On the other hand, when it is determined that the connection of the expander is checkable (No in step S110), the connection determination unit 504 proceeds to step S112.

In step S112, the bias determination unit 503 specifies the disk, of which the points are greater than or equal to the threshold value, as the abnormal device (step S112), and proceeds to step S122.

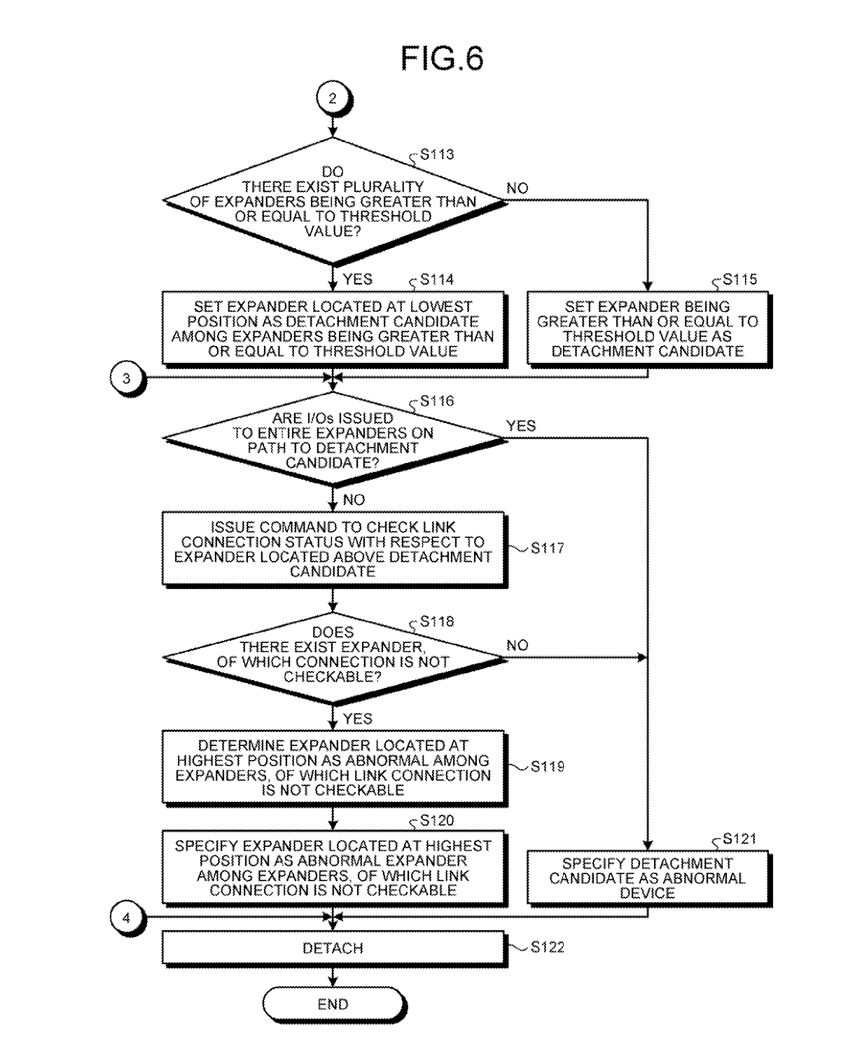

Next, a processing procedure after proceeding to step S113 will be described with reference to FIG. 6. The connection determination unit 504 determines whether or not there exist a plurality of expanders that are greater than or equal to the threshold value (step S113). When it is determined that there exist the plurality of expanders that are greater than or equal to the threshold value (Yes in step S113), the connection determination unit 504 sets the expander, which is located at the lowest position among the expanders being greater than or equal to the threshold value, as a detachment candidate (step S114), and proceeds to step S116.

On the other hand, when it is determined that there do not exist the plurality of expanders that are greater than or equal to the threshold value (No in step S113), the connection determination unit 504 sets the expander, which is greater than or equal to the threshold value, as a detachment candidate (step S115), and proceeds to step S116.

In step S116, the connection determination unit 504 determines whether or not I/Os are issued to the entire expanders on the path to the detachment candidate (step S116). When it is determined that no I/Os are issued to the entire expanders on the path to the detachment candidate (No in step S116), the connection determination unit 504 performs the following processing. That is, the connection determination unit 504 issues a command to check a link connection status with respect to the expanders located above the detachment candidate (step S117).

Subsequently, the connection determination unit 504 determines whether or not there exists an expander, of which the connection is not checkable (step S118). When it is determined that there exists the expander, of which the connection is not checkable (Yes in step S118), the connection determination unit 504 determines that the expander located at the highest position among the expanders, of which the link connection is not checkable, is abnormal (step S119). The connection determination unit 504 specifies the expander located at the highest position among the expanders, of which the link connection is not checkable, as the abnormal expander (step S120), and proceeds to step S122.

When it is determined that the I/Os are issued to the entire expanders on the path to the detachment candidate (Yes in step S116), the connection determination unit 504 proceeds to step S121. Also, when it is determined that there does not exist the expander, of which the connection is not checkable (No in step S118), the connection determination unit 504 proceeds to step S121.

In step S121, the connection determination unit 504 specifies the detachment candidate as the abnormal device (step S121), and proceeds to step S122. In step S122, the detachment unit 505 detaches the device specified as abnormal (step S122).

### Effects of First Embodiment

As described above, the storage device 1 according to the first embodiment may prevent the detachment of the normal device. As one example, in the storage device 1, the case where there is an abnormality in the expander 110 occurs. Also, one-time added point value (P_{EXP}) to the expander is 50 points, the added point value (P_{DISK}) to the disk is 65 points, and the threshold value of the points specifying the device as the abnormal area is 255 points.

When the storage device 1 repetitively performs I/O accesses to the disk 201a, all I/O accesses become errors. When the I/O access to the disk 201a is failed for the fourth time, the added points of the disk 201a exceed the threshold value, that is, 255 points.

In this case, the storage device 1 checks the number of I/O issues to the entire disks, and determines that the I/O accesses are biased to the disk 201a. The storage device 1 checks the connection status of the expander 210 mounted with the disk 201a, and determines whether or not the expander is abnormal. When the connection status of the expander 210 is not checkable, the storage device 1 specifies the abnormal expander. As a result, the storage device 1 may prevent the detachment of the normal disk 201a.

Subsequently, the storage device 1 specifies the abnormal expander. For example, the storage device 1 checks the connection status of the expander 110 located above the expander 210. When the connection status of the expander 110 is not checkable, the storage device 1 specifies the expander 110 located at the highest position as abnormal. As a result, the storage device 1 may prevent the detachment of the normal expander 210.

### [b] Second Embodiment

The present invention may also be carried out in various different forms, in addition to the above-described embodiment. In the second embodiment, another embodiment included in the present invention will be described.

System Configuration and the Like

In each processing described in the present embodiment, all or part of the processing described as being automatically performed may also be manually performed. Alternatively, all or part of the processing described as being manually performed may also be automatically performed by known methods. Furthermore, the processing procedures, control procedures, and specific names represented in the texts or drawings may be arbitrarily changed unless otherwise specified. Also, the information stored by the illustrated statistical point addition table 501 is merely exemplary, and the information need not be necessarily stored as illustrated.

Also, the bias determination unit 503 may determine the bias of the I/Os by using an approximate expression replaced with the minimum value (IO_{MIN}) by simplifying IO₀, IO₁, . . . IO_{N-1} in Equation (1). For example, in this case, the bias determination unit 503 uses the following Equation (3) as the approximate expression.

IO_{MIN}/IO_{MAX}<P_{DISK}−P_{EXP}/P_{EXP}(N−1) (3)

For example, by using Equation (3), when IO_{MIN}/IO_{MAX} is less than or equal to a predetermined threshold value, the bias determination unit 503 determines that there is the bias in the I/Os. For example, in the case where the number of the disks is 2, when the threshold value from Equation (3) is less than or equal to 30%, the bias determination unit 503 determines that there is the bias in the I/Os. Also, in the case where the number of the disks is 4, when the threshold value from Equation (3) is less than or equal to 10%, the bias determination unit 503 determines that there is the bias in the I/Os.

Also, according to various loads or usage conditions, the order of processing in each step of each processing described in each embodiment may be changed. For example, in the case where the storage device includes a single DE, when it is determined in step S103 illustrated in FIG. 4 that the points of the certain expander are greater than or equal to the threshold value, the threshold value determination unit 502 may proceed to step S122, instead of step S113.

Also, the respective components illustrated are functionally conceptual, and need not be necessarily configured physically as illustrated. For example, in the control program 321, the bias determination unit 503 and the connection determination unit 504 may be integrated. Furthermore, all or an arbitrary part of the respective processing functions executed in the respective apparatuses may be realized by a CPU and a program analyzed and executed by the CPU, or may be realized as hardware by a wired logic.

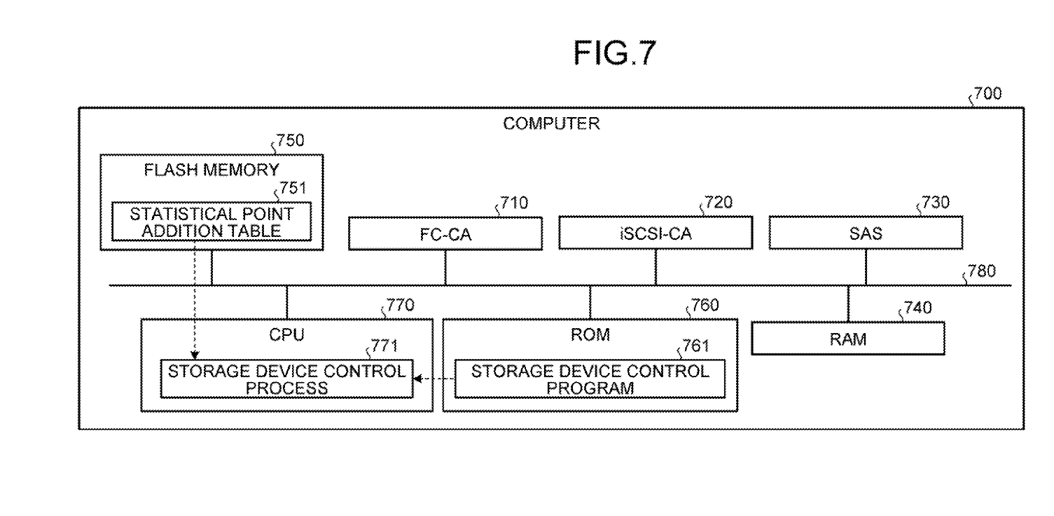

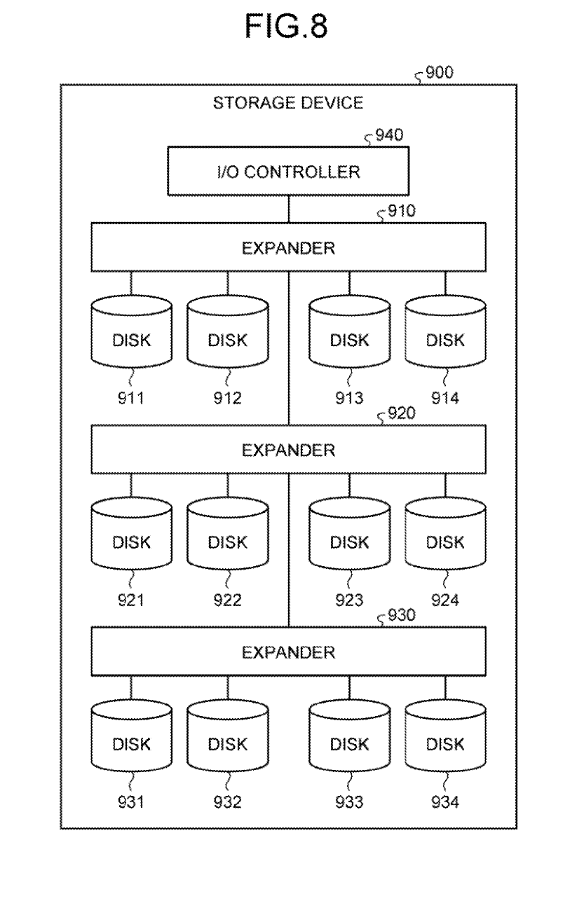

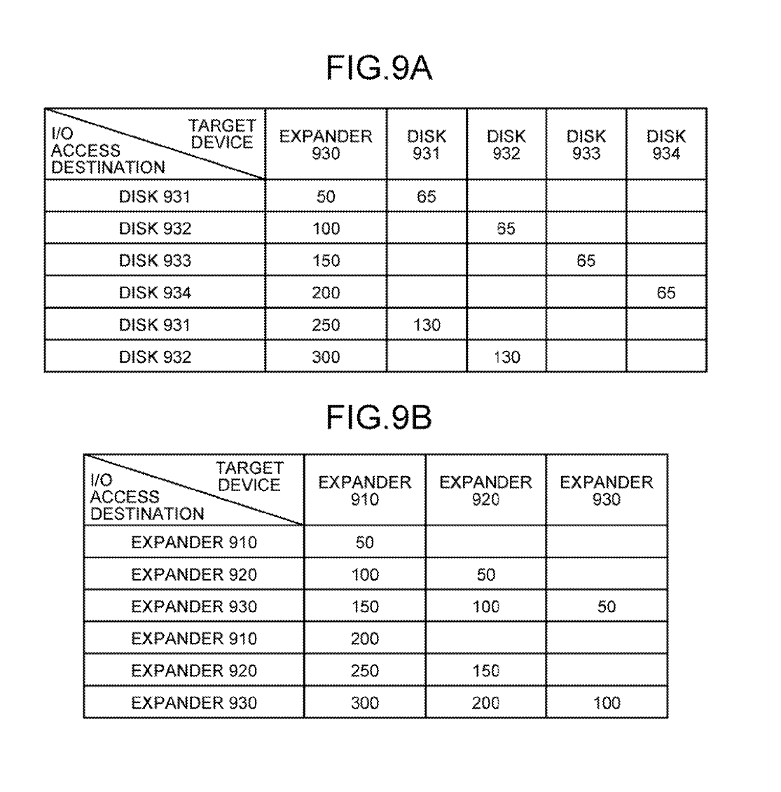

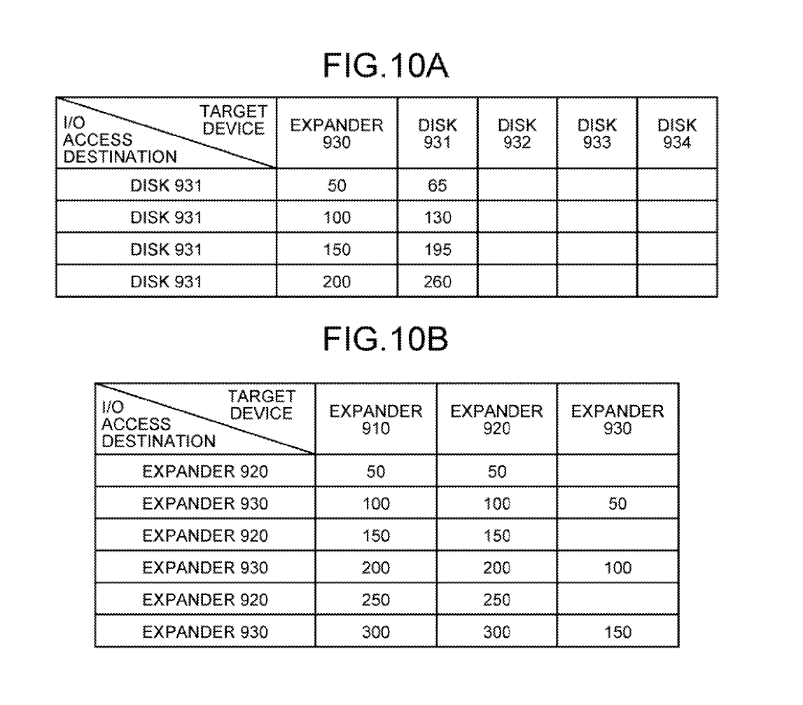

Also, a variety of processing described in the embodiment may be realized by executing a prepared program on a computer included in the storage device. Therefore, hereinafter, an example of a computer executing a storage device control program having the same function as the embodiment will be described with reference to FIG. 7. FIG. 7 is a diagram illustrating a computer that executes a storage device control program.

As illustrated in FIG. 7, a computer 700 includes an FC-CA 710 that is an interface with a host, an iSCSI-CA 720 that is an interface with the host, and a SAS 730 that is an interface with a disk device. Also, the computer 700 includes a RAM 740 that temporarily stores a variety of information, and a nonvolatile flash memory 750 that is rewritable and makes data not disappear even when power is turned off. Also, the computer 700 includes a Read Only Memory (ROM) 760, and a CPU 770 that executes a variety of arithmetic processing. Also, the respective units included in the computer 700 are connected through a bus 780.

The flash memory 750 stores a statistical point addition table 751 corresponding to the statistical point addition table 501 illustrated in FIG. 2. Also, the ROM 760 stores a storage device control program 761 having the same functions as the threshold value determination unit 502, the bias determination unit 503, the connection determination unit 504, and the detachment unit 505, which are illustrated in FIG. 2.

The CPU 770 refers to the statistical point addition table 751 read from the flash memory 750, and executes the storage device control program 761 read from the ROM 760 as a storage device control process 771.

Also, the storage device control program 761 need not be necessarily stored in the ROM 760, and the computer 700 may read and execute the program stored in a storage medium such as a CD-ROM. Moreover, the program may be stored in other computer (or server) or the like connected to the computer 700 through a public line, Internet, a LAN, a Wide Area Network (WAN), or the like, and the computer 700 may read the program from these and execute the read program.

According to an embodiment, detachment of normal components may be suppressed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage device, which performs input/output processing on a memory device through a
relay apparatus, the storage device comprising:
a memory; and
a processor coupled to the memory, wherein the processor executes a process comprising:
determining whether or not a cumulative value accumulated according to occurrence of error in the memory device during the input/output processing reaches a predetermined threshold value;
comparing when the determined cumulative value is greater than or equal to the threshold value, number of input/output processing on the memory device with number of input/output processing on another memory device mounted on the relay apparatus, and determining whether or not there is a bias;
determining when the bias is determined, whether or not a connection status is normal with respect to the relay apparatus; and
detaching when it is determined that the connection status of the relay apparatus is normal, the connection to the memory device.

2. The storage device according to claim 1, wherein the detaching includes detaching, when no bias is determined, the connection to the memory device.

3. The storage device according to claim 1, wherein the determining whether or not a connection status is normal includes determining, when the determined cumulative value of a certain relay apparatus is greater than or equal to the threshold value, whether or not a connection status is normal with respect to entire relay apparatuses located above the relay apparatus, and
the detaching includes detaching a connection to a relay apparatus located at the highest position among the relay apparatuses, of which the connection is determined as abnormal.

4. The storage device according to claim 1, wherein the determining whether or not a connection status is normal determines, when it is determined that the connection status of the relay apparatus mounted with the memory device being greater than or equal to the threshold value is abnormal, whether or not a connection status is normal with respect to entire relay apparatuses located above the relay apparatus, and
the detaching detaches a connection to a relay apparatus located at the highest position among the relay apparatuses, of which the connection is determined as abnormal.

5. A method for controlling a storage device that performs input/output processing on a memory device through a relay apparatus, the method comprising:
determining whether or not a cumulative value accumulated according to occurrence of error in the memory device during the input/output processing reaches a predetermined threshold value, using a processor;
comparing when the determined cumulative value is greater than or equal to the threshold value, number of input/output processing on the memory device with number of input/output processing on another memory device mounted on the relay apparatus, and determining whether or not there is a bias, using the processor;
determining when the bias is determined, whether or not a connection status is normal with respect to the relay apparatus, using the processor; and
detaching when it is determined that the connection status of the relay apparatus is normal, the connection to the memory device, using the processor.

6. A computer-readable recording medium having stored therein a program for controlling a storage device that performs input/output processing on a memory device through a relay apparatus, the program causing the storage device to execute:
determining whether or not a cumulative value accumulated according to occurrence of error in the memory device during the input/output processing reaches a predetermined threshold value;
comparing when the determined cumulative value is greater than or equal to the threshold value, number of input/output processing on the memory device with number of input/output processing on another memory device mounted on the relay apparatus, and determining whether or not there is a bias;
determining when the bias is determined, whether or not a connection status is normal with respect to the relay apparatus; and
detaching when it is determined that the connection status of the relay apparatus is normal, the connection to the memory device.
